(19) United States
(12) Patent Application Publication
(10) Pub. No.: US 2009/0187417 A1
(43) Pub. Date: Jul. 23, 2009

(54) Age and Identity Verification for Online Creative Works

(76) Inventor: James M. Lidestri, Hopewell Junction, NY (US)

Correspondence Address: FISH & RICHARDSON P.C., P.O BOX 1022, Minneapolis, MN, 55440-1022, US

(21) Appl. No.: 12/355,280

(22) Filed: Jan. 16, 2009

Related U.S. Application Data
(60) Provisional application No. 61/021,663, filed on Jan. 17, 2008.

(51) Int. Cl. G06Q 99/00

(52) U.S. Cl. 705/1

(57) ABSTRACT

A computer-implemented method of verifying the age and/or identity of a participant in a digital creative work to be published includes storing a participant profile in memory, confirming a date of birth (DOB) input by the participant in the participant profile, and identifying the digital creative work. A date of production (DOP) associated with the creative work is determined, an age at the time of production (ATOP) for the participant is determined based on DOB and DOP, and the digital creative work is published over a network, if the ATOP exceeds a predetermined threshold.

### CROSS-REFERENCE TO RELATED APPLICATION

The present application claims priority to U.S. Prov. Pat. App. No. 61/021,663, filed on Jan. 17, 2008, under 35 U.S.C. §119(e). U.S. Prov. Pat. App. No. 61/021,663 is expressly incorporated herein by reference in its entirety for all purposes.

### TECHNICAL FIELD

The present disclosure relates to posting creative works online, and more particularly to computer-implemented methods, computer readable medium, and systems for verifying the age and identity of participants in online creative works.

### BACKGROUND

The advent of the Internet has enabled the transfer of information and data to millions of users worldwide. The Internet has also enabled electronic commerce, or e-commerce, which includes the buying and selling of products and/or services over electronic systems such as the Internet, and other computer networks. The amount of electronic trade has rapidly grown over the last decade or so.

Products that are sold through e-commerce can include creative works that are provided in electronic form. Such creative works can include digital writings (e.g., books, papers, articles), images, photos and videos. Digital creative works can be advertised online through a seller website, for example, and can be electronically transferred to a buyer, upon purchase. The online presentation of creative works can present significant problems. In the case of images, photos and/or videos, the creative works can include sexually explicit content. In such cases, the age of models participating in the content must conform to legal age requirements.

### SUMMARY

The present disclosure is directed to computer-implemented methods, computer readable medium, and systems for verifying the age and identity of participants in online creative works. In some implementations, a computer-implemented method includes storing a participant profile in memory, confirming a date of birth (DOB) input by the participant in the participant profile, and identifying the digital creative work. A date of production (DOP) associated with the creative work is determined, an age at the time of production (ATOP) for the participant is determined based on DOB and DOP, and the digital creative work is published over a network, if the ATOP exceeds a predetermined threshold.

In some implementations, the method further includes determining identity information from an image uploaded to the participant profile, wherein the confirming is achieved based on the authentication information. In some embodiments, the image is that of a government issued identification, and the identity information is determined by algorithmically scanning the image. In some embodiments, the method further includes retrieving authentication information from a database based on the identity information, and authenticating the identity information based on the authentication information. The method can further include determining an authenticity of the image based on the authentication information.

In other implementations, the DOP is determined from stored data that is associated with the digital creative work.

In still other implementations, the DOP is input by a user.

In some implementations, a computer readable medium is encoded with a computer program comprising instructions that, when executed, operate to cause a computer to perform operations. The operation include storing a participant profile in memory, confirming a date of birth (DOB) input by the participant in the participant profile, and identifying the digital creative work. A date of production (DOP) associated with the creative work is determined, an age at the time of production (ATOP) for the participant is determined based on DOB and DOP, and the digital creative work is published over a network, if the ATOP exceeds a predetermined threshold.

In some implementations, a system includes a network, and a computer that communicates over the network. The computer includes a computer-readable medium encoded with a computer program comprising instructions that, when executed, operate to cause a computer to perform operations. The operations include storing a participant profile in memory, confirming a date of birth (DOB) input by the participant in the participant profile, and identifying the digital creative work. A date of production (DOP) associated with the creative work is determined, an age at the time of production (ATOP) for the participant is determined based on DOB and DOP, and the digital creative work is published over a network, if the ATOP exceeds a predetermined threshold.

The details of one or more implementations of the present disclosure are set forth in the accompanying drawings and the description below. Other features, objects, and advantages of the invention will be apparent from the description and drawings, and from the claims.

### DESCRIPTION OF DRAWINGS

FIG. 1 is a functional block diagram of an exemplar computer system.

FIG. 2 is an illustration of an exemplar screen-shot of an implementation of the present disclosure.

FIG. 3 is an illustration of another exemplar screen-shot of an implementation of the present disclosure.

FIG. 4 is a flowchart illustrating exemplary steps executed in accordance with some implementations of the present disclosure.

### DETAILED DESCRIPTION

The present disclosure is directed to a process that enables a user to verify the legal ages and identities of participants in content that is published online. As used herein, the term content can include images, photos, and videos. This process enables the user to quickly and easily determine if all participants meet established age requirements, and to verify the identity of the participants. As used herein, the user includes a person, or persons, who make available, or otherwise distribute or monitor online content. By way of non-limiting example, the user can include, but is not limited to, a model, a photographer, an actor, a videographer, an agent, a publisher, and/or a third party.

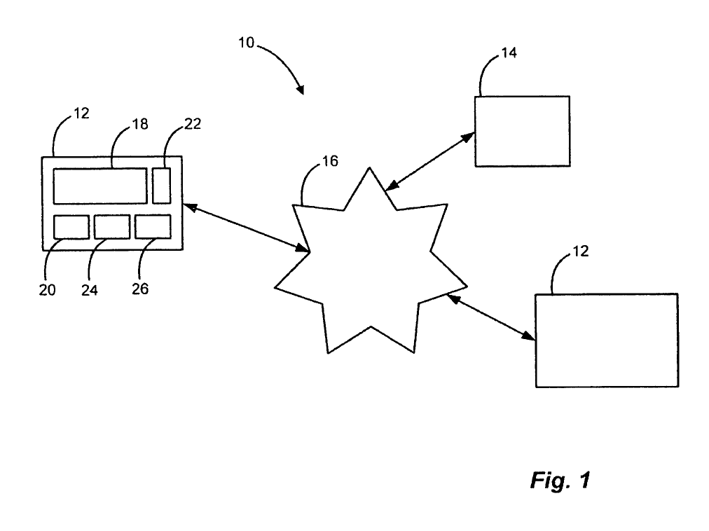

Referring now to FIG. 1, various implementations of the present disclosure can be realized using computer systems and computer programs. An exemplar computer network 10 includes a plurality of computers 12, and one or more servers 14 that communicate with one another over a network 16. The network 16 can include, but is not limited to, a local area network (LAN), a wide area network (WAN), and/or the Internet. An exemplary computer 12 includes a display 18, an input device 20, such as a keyboard and/or mouse, memory 22, a dataport 24, and a central processing unit (CPU) 26. The display 18 can include a CRT (cathode ray tube) or LCD (liquid crystal display) monitor for displaying information to the user. The input device 20 can include a keyboard, and/or a pointing device such as a mouse or a trackball, by which the user can provide input to the computer 12. Other kinds of devices can be used to provide for interaction with a user as well; for example, input from the user can be received in any form, including acoustic, speech, or tactile input.

A software program, which executes one or more implementations of the present disclosure, can be resident on one or more of the computers 12, and/or on the server 14. For example, the software program can be resident on a particular computer 12, which the user implements to verify the age and identity of participants. Additionally, or in the alternative, the user can access a website through the network 16. The user performs the age and identity verification, as described above, using the website.

In some implementations, a participant enters his/her date of birth (DOB), and the date of production (DOP) of the content. In the case of multiple participants, each participant enters their DOB. As an alternative, the user can enter the participant's DOB, and/or the DOP information. The participant's DOB is compared with the DOP to determine the participant's age at the time of production of the Content (ATOP). The user can accept or reject the publishing of the content if the ATOP of any participant violates any established age requirements. It is anticipated that the participant may be an agent of the actual participant depicted in the creative work. In some implementations, the participant(s) or the user can input ATOP, which can be stored.

Other participant information can be input including, but not limited to, full, legal name, social security number, driver's license number, passport number, and/or government-issued identification number, date of issue, state/province, or government of issue, professional aliases, previously published works (e.g., names, dates, locations, publishers names and addresses), address and contact information (e.g., telephone number and/or e-mail address). The participant(s) can upload a digital copy of proof of birth to confirm DOB. This can be in addition to entering the DOB, or in lieu of entering the DOB. It is also anticipated that the participant(s) can submit a physical copy of DOB documentation. This can be done in addition to entering the DOB and/or the digital copy, or in lieu of entering the DOB and/or digital copy.

The user or participant can enter additional information about the content to be published. The additional production information can include, but is not limited to, name, title, description, location of production, names of production personnel, production permit information, and publisher information (e.g., name, address, contact information).

The DOP can be automatically determined. For example, the user or participant loads the original content, partially or completely, in unedited and unmodified form. The DOP is determined based on embedded file details. This can be done in addition to entering the DOP, or in lieu of entering the DOP. In addition, or in the alternative, the user or a participant can upload a digital copy of a legal contract that stipulates the DOP. It is also anticipated that the participant(s) can submit a physical copy of a legal contract that stipulates the DOP. This can be in addition to entering the DOP and/or original content, or in lieu of entering the DOP and/or original content. The ATOP can also be determined automatically, based on the determined DOB, and DOP information.

In addition, or in the alternative, the user or participant can upload the final content to be published, which can be a subset of the original content and may be modified, or edited from its original form.

In some implementations, one or more databases are searched based on known participant information. In this manner, the identity and age of each participant can be further verified. The additional information is used to query central database(s) to verify or determine the identity and/or DOB of the participant(s). In addition, or in the alternative, the DOB of a participant can be determined by analyzing the uploaded digital proof of birth and/or searched databases. In further implementations, the participant(s) can enter a unique identification number, or can scan the unique identification number from a physical identification card), which can be used to query central database(s) to determine the identity and DOB of the participant(s). The participant(s) or the user can also enter a unique identification number, which can be used to query central database(s) to determine the DOP.

In some implementations, the participant(s) can submit personal biometric information that can be used to query central database(s) to determine identity and/or DOB. Biometric information can include, but is not limited to, thumbprint scans, hand scans, iris scans, retinal scans, DNA analysis and speech recognition.

The participant(s) or the user can save certain information in a personal profile so that the re-entering of participant data can be eliminated upon future requests to publish creative works. Such information can include, but is not limited to be the participant(s) DOB, the digitized proof of birth, unique identification numbers, personal biometrics, and personal information such as one or more of legal name, address and contact information. In these cases, the participant or the user can identify the participant(s). In this manner, creative works that are submitted for online posting can be automatically accepted or rejected based on the previously stored information. In other implementations, an accept or reject recommendation can be generated for review by the user. The user is then able to review the information, and can follow the recommendation, or can ignore the recommendation.

All of the entered, submitted and/or searched data that represents the entire production can be stored for future reference. This information can include, but is not limited to, any or all of the participant(s) information, DOP information, ATOP information and production information including but not limited to name, title, description, location of production, names of production personnel, production permit information, and publisher information (e.g., name, address, contact information). Further, unique identification numbers can be assigned to identify stored participant and production information.

In other implementations, the user is able to examine one or all of the participant identity information, and/or DOB information, and the production information. For example, the user can enter participant data items to search central database(s) for desired participant(s). If a participant is found, some or all of the stored participant data for a particular participant or participants can be displayed to the user. The stored participant data can include, but is not limited to, DOB, the digitized proof of birth, unique identification numbers, personal biometrics, and personal information such as legal name, address and/or contact information and related production information for that user. Similarly, the user can enter production data items to search central database(s) for desired production information. If found, some or all of stored production data is displayed to the user. The production data can include, but is not limited to, the participant information, DOP information, ATOP information, and production information including but not limited to name, title, description, location of production, names of production personnel, production permit information, and publisher information (e.g., name, address, contact information).

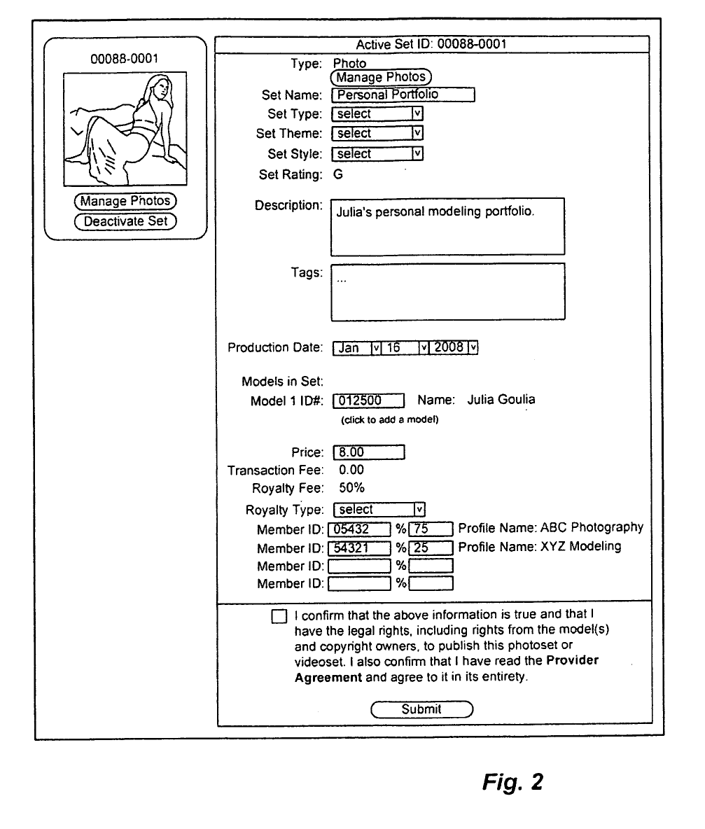

Referring now to FIG. 2, an illustration of a screen-shot of an exemplar implementation of the present disclosure is provided. The screen-shot includes a first pane that provides a thumbnail photo that is representative of a group, or set of photos, videos, or other content. A second pane is provided, through which the user is able to set parameters relating to the content including the assignment of royalties for sales of the content. The user can input set information including, but not necessarily limited to, a set name, a set type, a set theme, a set style, a description, tags, production date, model(s) in the set. The user can also input information corresponding to sales of the content. For example, the user can provide a price, a royalty type, can identify royalties parties, and can assign royalty rates to each.

Exemplar set types can include, but are not limited to, professional, amateur, candid, self. Exemplar set themes can include, but are not limited to, portfolio, glamour, casual, fitness, fetish and swimwear. Exemplar set styles can include, but are not limited to, non-nude, nude, implied, topless and erotic. The user can provide a description of the set, which description can be posted for review by potential purchasers of the content. The user can also provide tags, which are keywords that describe the content. In this manner, a potential purchaser can input search terms into a search engine, which search terms may correspond to the tags. The user can also input the date of production (DOP) of the content. In other embodiments, the DOP can be determined based on data that is associated with the digital content. For example, the DOP could be determined from meta-data that is associated with a file of the digital content.

The user can also input the model(s) associated with the particular content. As explained in further detail below, the model(s) can have a model identification that corresponds to a pre-stored profile that includes all relevant information associated with the model(s). For example, after inputting the model identification, the model's name is automatically displayed. In the present example, the model ID ‘012500’ is input, and is associated with model ‘Julia Goulia’. Date of birth (DOB) information can be obtained from the model's profile, as discussed in further detail below. The DOB can be compared to the DOP to determine the ATOP, discussed above. The ATOP can be compared to a threshold value to determine whether the model was of a sufficient age at the time that the content was produced.

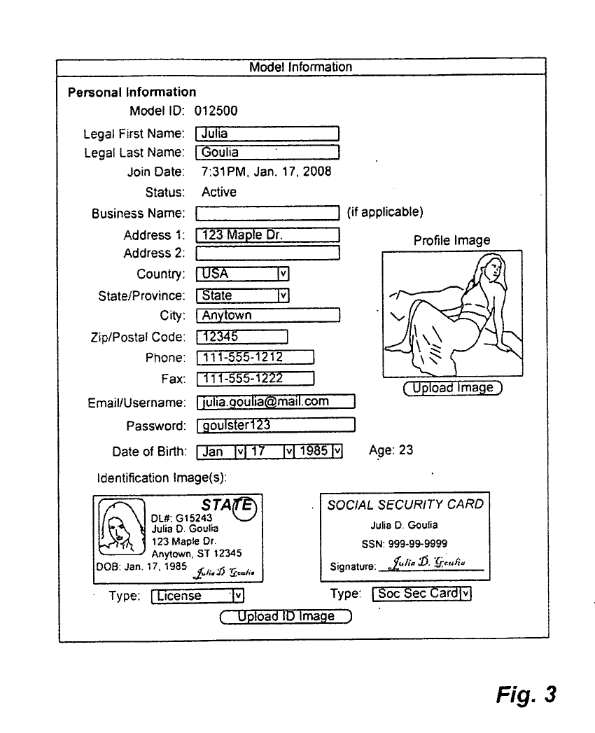

Referring now to FIG. 3, an illustration of another screen-shot of the exemplar implementation of the present disclosure is provided. The screen-shot of FIG. 3 is representative of an exemplar model profile screen, in which a model creates a model profile that is stored in memory. The model profile includes personal information associated with the model, which personal information can be used to confirm the model's identity and date of birth (DOB).

The profile information includes a model ID that can be assigned to the model by a web-site operator, through which the digital content including the model can be distributed. Other personal information includes the models' legal first name, legal last name, a business name, if applicable, an address including street, country, state/province, city, and ZIP/postal code. Other information can include telephone number and fax number. When creating the profile, the model inputs an email address, which can serve as a username for logging into a web-site, through which the digital content including the model can be distributed. In the present example, the email address and username are the same, however, it is contemplated that the email address and username can be different. The model also provides a personal password that is associated with the username for log-in purposes. The model can also upload a profile image.

When creating the profile, the model must also input identity and age information, which can be used to confirm the model's identity and age, as discussed in further detail below. In the example of FIG. 3, the model can input his/her DOB by selecting the month, day and year from a drop-down menu. In other embodiments, other input means can be implemented. Upon inputting the DOB, the model's current age is automatically determined and is displayed. The model may also be required to provide identity confirmation information, which can include, but is not limited to, a driver's license, a government issued identification card, a green card, a social security card, and/or a passport. The identity confirmation information can be provided in digital form. For example, the identity confirmation information can be digitally scanned and uploaded by the model. In the example of FIG. 3, the model has uploaded a digital image of a drivers license, as well as a digital image of a social security card.

It is appreciated that the information provided in FIG. 3 is not exhaustive, and other information can be provided. For example, other information can include, but is not limited to, credit card information, birth certificate information, passport information, billing address information (if different than personal address, for example), green card information, and/or tax information (e.g., tax forms for reporting royalty payments).

The model's age and identity can be confirmed using the identity confirmation information. For example, a facial recognition algorithm can be implemented to compare a photo from an identification card with the profile image. In the example of FIG. 3, the model's drivers license image can be scanned, and the profile image can be scanned. The images can be compared to determine whether the person depicted in the profile image is the same as that depicted in the drivers license. As another example, the identification card can be scanned for relevant information including, but not limited to, an identification number, a DOB, and/or an address. The identification number can be used to access a database to determine the accuracy of the information input by the model. An example of this is described in detail below.

In the example of FIG. 3, the drivers license image can be algorithmically scanned to determine information including, but not limited to, the drivers license number (e.g., ‘G15243’), name (e.g., ‘Julia D. Goulia’), the DOB (e.g., ‘Jan. 17, 1985’), and/or the address. This information can be compared to that input by the model. As used herein, the term ‘algorithmically scanned’, or ‘algorithmically scanning’ refers to processing of the image using a processing algorithm or routine to identify relevant information from the image including, but not limited to, facial features, numbers, and/or letters. The legal name, address and/or DOB determined from the image can be compared to that input by the model to ensure that they are consistent. If inconsistencies are present, the authenticity of the information can be questioned. In another example, the drivers license number can be used to reference a database, from which information including, but not limited to, DOB and/or address can be accessed. The information accessed from the database can be compared to that input by the model, and/or to that obtained by scanning the drivers license image. For example, the DOB provided by the database can be compared to the DOB provided in the drivers license image to ensure that they are consistent (e.g., to ensure that the DOB from the drivers license image was not forged). Further, the drivers license number can be used to determine that the drivers license image is representative of a duly issued drivers license and not a forgery. For example, the drivers license number can be used to reference a database, and the authenticity of the drivers license image uploaded by the model can be questioned, if there is not a matching drivers license number in the database.

In the example of FIG. 3, the social security card image can be algorithmically scanned to determine information including, but not limited to, name (e.g., ‘Julia D. Goulia’), and/or social security number (SSN) (e.g., ‘999-99-9999’). The information from the image can be compared to that input by the model to ensure that they are consistent. If inconsistencies are present, the authenticity of the information can be questioned. In another example, the SSN can be used to reference a database, from which information including, but not limited to, name, DOB and/or address can be accessed. The information accessed from the database can be compared to that input by the model, and/or to that obtained by scanning the social security card image. For example, the DOB provided by the database can be compared to the DOB provided in the drivers license image to ensure that they are consistent (e.g., to ensure that the DOB from the drivers license image and/or the social security card image was not forged). Further, the SSN can be used to determine that the social security card image is representative of a duly issued social security card and not a forgery. For example, the SSN can be used to reference a database, and the authenticity of the social security card image uploaded by the model can be questioned, if there is not a matching SSN in the database.

As noted above, the drivers license and social security card of FIG. 3 are merely exemplar representations of identification information that can be provided by the model. Other can include, but is not limited to, a driver's license, a government issued identification card, a green card, a social security card, and/or a passport. In each case, information provided from analysis of the image(s) can be compared to that input by the model, and/or that available from a database to evaluate the authenticity and accuracy of the information, and to confirm the identity and DOB of the model. Once confirmed, the DOB of the model can be used to determine ATOP, as described herein.

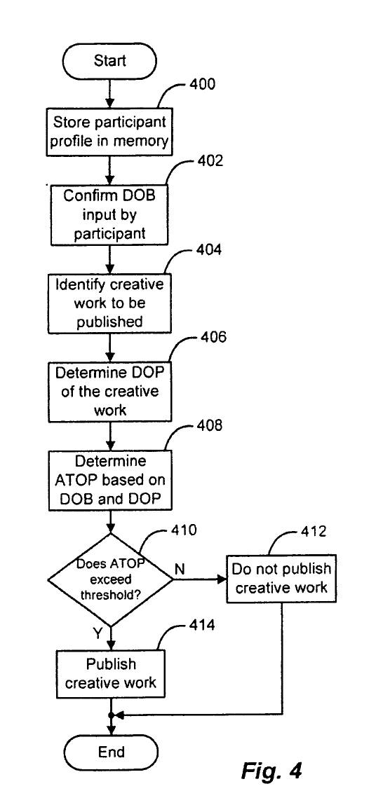

FIG. 4 is a flowchart illustrating exemplary steps that can be executed in accordance with some implementations of the present disclosure. In step 400, a participant profile is stored in memory. In step 402, a date of birth (DOB) input by the participant in the participant profile is confirmed. A digital creative work that is to be published is identified in step 404. In step 406, a date of production (DOP) associated with the creative work is determined. In step 408, an age at the time of production (ATOP) for the participant is determined based on DOB and DOP. It is determined whether the ATOP exceeds a threshold in step 410. If the ATOP does not exceed the threshold, the creative work is not published in step 412. If the ATOP exceeds the threshold, the creative work is published over a network in step 414.

The processes of the present disclosure can be implemented in digital electronic circuitry, or in computer hardware, firmware, software, or in combinations thereof. The invention can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Implementations of the present disclosure can be performed by one or more programmable processors executing a computer program to perform functions of the invention by operating on input data and generating output. Processes can also be performed by, and apparatus can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Processes of the present disclosure can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network, a wide area network, and the Internet.

A number of implementations of the disclosure have been described. Nevertheless, it will be understood that various modifications may be made without departing from the spirit and scope of the disclosure. More specifically, implementations of the method and system of the present disclosure can include various combinations of the features described herein. For example, implementations of the method and system can include a plurality of the features described herein, while other implementations can include all of the features described herein.

What is claimed is:

1. A computer-implemented method of verifying the age and/or identity of a participant in a digital creative work to be published, comprising:
storing a participant profile in memory;
confirming a date of birth (DOB) input by the participant in the participant profile;
identifying the digital creative work;
determining a date of production (DOP) associated with the creative work;
determining an age at the time of production (ATOP) for the participant based on DOB and DOP; and
publishing the digital creative work over a network, if the ATOP exceeds a predetermined threshold.

2. The method of claim 1, further comprising determining identity information from an image uploaded to the participant profile, wherein the confirming is achieved based on the authentication information.

3. The method of claim 2, wherein the image is that of a government issued identification, and wherein the identity information is determined by algorithmically scanning the image.

4. The method of claim 2, further comprising:
retrieving authentication information from a database based on the identity information; and
authenticating the identity information based on the authentication information.

5. The method of claim 4, further comprising determining an authenticity of the image based on the authentication information.

6. The method of claim 1, wherein the DOP is determined from stored data that is associated with the digital creative work.

7. The method of claim 1, wherein the DOP is input by a user.

8. A computer-readable medium encoded with a computer program comprising instructions that when executed, operate to cause a computer to perform operations comprising:
storing a participant profile in memory;
confirming a date of birth (DOB) input by the participant in the participant profile;
identifying the digital creative work;
determining a date of production (DOP) associated with the creative work;
determining an age at the time of production (ATOP) for the participant based on DOB and DOP; and
publishing the digital creative work over a network, if the ATOP exceeds a predetermined threshold.

9. The computer-readable medium of claim 8, further comprising determining identity information from an image uploaded to the participant profile, wherein the confirming is achieved based on the authentication information.

10. The computer-readable medium of claim 9, wherein the image is that of a government issued identification, and wherein the identity information is determined by algorithmically scanning the image.

11. The computer-readable medium of claim 9, further comprising:
retrieving authentication information from a database based on the identity information; and
authenticating the identity information based on the authentication information.

12. The computer-readable medium of claim 11, further comprising determining an authenticity of the image based on the authentication information.

13. The computer-readable medium of claim 9, wherein the DOP is determined from stored data that is associated with the digital creative work.

14. The computer-readable medium of claim 9, wherein the DOP is input by a user.

15. A system, comprising:
a network;
a computer that communicates over the network, and that has a computer-readable medium encoded with a computer program comprising instructions that, when executed, operate to cause a computer to perform operations comprising:
storing a participant profile in memory;
confirming a date of birth (DOB) input by the participant in the participant profile;
identifying the digital creative work;
determining a date of production (DOP) associated with the creative work;
determining an age at the time of production (ATOP) for the participant based on DOB and DOP; and
publishing the digital creative work over a network, if the ATOP exceeds a predetermined threshold.

16. The system of claim 15, wherein the operation further comprise determining identity information from an image uploaded to the participant profile, wherein the confirming is achieved based on the authentication information.

17. The system of claim 16, wherein the image is that of a government issued identification, and wherein the identity information is determined by algorithmically scanning the image.

18. The system of claim 16, wherein the operation further comprise:
retrieving authentication information from a database based on the identity information; and
authenticating the identity information based on the authentication information.

19. The system of claim 18, wherein the operation further comprise determining an authenticity of the image based on the authentication information.

20. The system of claim 15, wherein the DOP is determined from stored data that is associated with the digital creative work.
